(19) United States
(12) Patent Application Publication
(10) Pub. No.: US 2004/0220869 A1
(43) Pub. Date: Nov. 4, 2004

(54) Method to enable customers to respond to prices in a pool type energey market

(76) Inventor: Anil Lasantha Michael Perera, Vermont South (AU)

Correspondence Address: WOOD, PHILLIPS, KATZ, CLARK & MORTIMER, 500 W. MADISON STREET, SUITE 3800, CHICAGO, IL, 60661, US

(21) Appl. No.: 10/362,557

(22) PCT Filed: Aug. 16, 2001
(86) PCT No.: PCT/AU01/01023

(30) Foreign Application Priority Data
Aug. 21, 2000 (AU) PQ 9576

(51) Int. Cl. G06F 17/60

(52) U.S. Cl. 705/37; 705/35

(57) ABSTRACT

A merchant and a customer have an agreement for the trading of energy units wherein the customer pays a contracted sum and the applicable wholesale market pool price for excess units of energy and receives the wholesale market pool price for unused units of energy. A system monitors and controls the energy usage of the customer. The system includes a metering means (105), a communication means (123, 124) receiving pricing information, a computing means (103) accumulating information from the metering means and communication means and determining a preferred trading outcome, and switching means controlling energy supply to the energy consuming devices to achieve the preferred trading outcome.

### FIELD OF THE INVENTION

The present invention relates to a new electronic commerce system for trading of products such as electricity and gas, whose underlying price is centrally set by the equivalent of a pool market. More specifically the invention enables even small customers to trade their response in real time to prices in a pool type market and thereby obtain a financial benefit commensurate to the pool price impact for that interval of time.

### NOTICE REGARDING DISCLOSURE OF COPYRIGHT MATERIAL

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND DESCRIPTION

The restructuring of the electricity markets that started in countries like the United Kingdom, New Zealand and Australia, has now spread to many parts of North and South America, Europe and even to Asia. The restructuring of the electricity markets had two key innovative features, one is introducing competition to the supply end of the market and the other was competition at the retail end.

The introduction of competition at the electricity supply end (generation) has produced number of competitive supply models, one end of the spectrum being the model adopted by Australia—which is an energy only gross pool (mandatory for all output from generation units over 30 MW to be sold through the pool market) with almost real time pricing (dispatch prices are set every five minutes for the next five minute period). The gross pool electricity market concept originated in England & Wales (E&W) where pool prices were decided the day ahead and a capacity payment was decided closer to dispatch. The E&W is now migrating to a ‘net pool’ arrangement (recognizes bilateral contracts and the pool only clearing the ‘overs’ and ‘unders’). Many countries follow the ‘net pool’ concept with a clearing pool market only to settle the ‘overs’ and ‘unders’.

Some of the common features of all these electricity pools are:

the complexity of the price setting process,

the large volume of market information required to optimise decision making; and

the very high prices that can occur in the pool eg over 100 times annual average price in the Australian National Electricity Market (NEM) where the price cap is $5,000/MWh.

As the prices were decided a day ahead in the original E&W gross electricity pool market, it enabled a few large customers to take supply based on the actual pool price decided the day ahead, generally termed ‘pool pass through’ (PPT) prices. They could afford to have special staff, who closely monitor pool demand forecasts and generator bidding behavior so as to form their own forecasts of pool price. With day ahead pricing there was sufficient time to enable customers' production schedules to be optimized taking account of the forecast pool price for energy.

The complexity of the pool market and the ever present risk of very high prices, has meant Retailers try to manage the pool price risk by purchasing pool price hedge contracts from the generators or other parties offering pool price risk cover. The end-use customers are also concerned about the risk of very high prices in the pool and invariably opt for fixed price contracts from their selected Retailer. A retail fixed price contract will normally incorporate a price premium on account of pool price hedge costs of energy either explicitly or implicitly. The fixed price contracts normally have different prices for energy used in different time periods and these energy prices may also vary by day of the week and by season, also known as time-of-use (TOU) prices. Usually there are no quantity limits. A retail supply contract with TOU prices normally includes the pass through of network tariff charges and pass-through of other regulated charges—some of them varying with energy consumption and others in the form of periodic charges fixed for the duration of the contract. In markets where Ancillary Services and Network Congestion are cleared by separate clearing markets, these costs are often passed through to end customers either as a direct pass-through cost or through a rolling fixed cost recovery process. This type of pool market is also being introduced for gas, eg the Victorian gas market operated and managed by Vencorp. The components of the charges are different from those applicable in the electricity market, but the concepts are very similar. Gas suppliers and those holding (excess or arbitrage) entitlements to purchase gas, bid for the right to supply the gas system demand requirements for the day and the day's clearing price applies to all gas traded that day.

A major shortcoming of most electricity and gas pool markets is the lack of effective demand side response in real time. In some markets, eg Californian Electricity Pool, the Retailers bid for their requirements needed to service their customers' load. But in reality there is very little capacity for the Retailer to influence aggregate demand—so necessary to have an effective influence on pool price. Proponents of pool type markets emphasise the benefits of supply side competition, but that is only true while there is abundant excess supply capacity. When supply and demand are close to balance, there is bound to be one or more suppliers who hold market power (demand cannot be met without some output from that supplier). This lack of countervailing power on the demand side has resulted in frustrated efforts at regulating pool market outcomes, eg the many reports and the litany of unsuccessful measures tried by regulators in the UK, Australia, California, etc.

It is an intention of this invention to provide the countervailing power in pool type electricity and gas markets by enabling end use customers to profitably respond in real time to price excesses in the pool market.

Current technological developments provide a platform for customers to be informed of the pool price in near real-time and will enable some of them to avoid consumption and so avoid paying high prices. But for most customers this comes at a high price in terms of time and effort. Take the case of a small business where electricity cost is only 5% of its final product sale price. To deal with the risk of the pool price reaching 100 times annual average price, he has three choices:

he can take a PPT price with a view to suspending energy consumption (production) when pool price reaches (say) 40 times annual average price (ie when electricity cost is twice the product selling price)

he can take a PPT price and decide to continue production even when pool price reached 100 times annual average

he can take a contract fixed price that includes a price premium of around 10% on the annual average price.

Clearly, a) involves the customer in substantial bother and cost—eg at what price level will he start stopping production, what are the implications of stopping production (start/stop cost, delivery schedules, increase in rejects, idle time payments, etc.), option b) is not a sound commercial proposition as it could have severe financial repercussions, even leading to bankruptcy. Almost all business customers in Australia now choose option c).

The situation would be no different when it comes to supplying domestic customers. Domestic customers also would consider the price risk from volatile pool prices as being significantly higher than their willingness to accept that risk, specially without easy access to price information and their unwillingness to be economically compelled to forgo energy usage for extended periods when prices are high. When there is a power outage, the householder may complain that the pot roast was affected or that some food items in the freezer went bad, but in general their complaints are less than from business customers. Number of studies on the assessment of outage cost, confirm this. The consensus view being that outage cost to an average residential customer is less than one fifth the outage cost to an average business customer. The challenge is to find a way to harness the low outage cost of small customers like the domestic customers, as a means to contain the incidence of high prices in the pool market. When the retail contestability threshold is down to the level of domestic customers, much greater aggregate demand side response to high prices in the pool becomes possible, if there is a way to access the large aggregate load of these customers who in general place less value on interruptible load.

A further challenge facing industries like electricity and gas, that have introduced pool markets, is to find effective means to enable demand side to respond to short duration supply constraints, so that supply and demand can be balanced without having to constantly add new supply capacity that may be needed only a few days in the year or resorting to enforced supply restrictions. It would also help dissuade those with supply side market power from trying to maintain a sharp incline in the supply curve at around the forecast demand level. Society would be better served if the high price cap intended to act as an incentive to increase supply capacity was equally applicable to the demand side customers to engage in demand response options. It is an intention of this invention to enable the end use customer to get the full financial benefit of the occasional high pool prices that currently provide a positive incentive only to the supply side.

Unlocking the very large negative consumer surplus (utility value to the customer minus the market price) and giving access to financial benefits equivalent to the very high pool prices that occur now and then, is not the only objective of the invention. The invention also enables access to greater financial rewards than the large negative consumer surplus of particular customer groups eg residential customers. Innovative developments in the airline industry come to mind, in particular the ‘reverse auction’ process employed to solve the problem of overbooked seats. The process enables the airline to consistently increase capacity utilization (decreased empty seats) than is possible by trying to ensure there is no overbooking. The economic payout to the willing customer, who gives up a seat, is small compared to the very large extra revenue the airline makes by regular overbooking. In a similar vein, the financial incentive for demand side response, which on the margin will reduce excessive pool price, can be higher than the pool price itself—when taking into consideration the full extent of the demand side exposure to the very high pool price that could result if not for the countervailing power of that demand side response. Given that end customers have different thresholds for engaging in demand management, allowing the customer to set the price will tend to accommodate a range of prices to achieve a given level of demand reduction that would be hard to match with a fixed price incentive.

Adding such a Price Premium to the underlying Pool Price would result in a revised price impact figure (Net Impact Price)—giving the customer a greater financial incentive than if only the Pool Price was to apply.

The significance of the invention if utilized by a sufficiently large number of small customers is that it delivers very effective demand side response in a pool type market. The potential for demand side response is higher when the value of lost load is lower and the aggregate load reduction through the use of the invention has a greater contribution to public benefit than through the reduction of higher valued load by big industrial or commercial customers—as has been the traditional response within the energy supply industry up to now. The net impact of the aggregate automatic response to price excursions in the pool will restore the power of the invisible hand Adam Smith talks of when expounding the merits of free markets. With the use of the invention, higher the pool price excursion, the greater will be the aggregate automated response to reduce energy consumption.

Yet another intention of the invention is to facilitate e-commerce. The great attraction of e-commerce is that it promotes innovation and reduces the marginal cost of commercial transactions. Different industries pose different levels of difficulty to new entrants. Electricity and gas supply industry pose higher levels of difficulty than most other industries. The on-going restructuring of the two industries has separated the retail part from the physical delivery of the product, but it still requires significant technical inputs to interact in the wholesale market and to satisfy regulatory license requirements. In number of countries we have seen the emergence of buying groups and load aggregators, where customer loads are combined together to get a better deal from the Retailer due to the greater bargaining power. The application of the invention can be likened to the ‘credit card’ revolution that changed the age-old habits of cash handling. The invention introduces the ‘Merchant’ who is the pseudo Retailer as much as the ‘credit card’ is the pseudo cash. It is possible that the Merchant and the Retailer are the one and same entity but it is also possible that they are two different entities. The Merchant will not only have the advantage of the greater bargaining power in negotiating a supply contract but will also have a ‘price responsive’ and diversified aggregate load—which is valuable as a natural price hedge. The Retailer as the Merchant can draw substantial benefit from the inherent ‘hedge’ characteristics of such price responsive aggregate load. Depending on circumstances, a savvy customer could also assume the role of the Merchant.

### DESCRIPTION OF RELATED ART

Traditionally electricity pricing has attempted to empower the end use customer to respond to energy supply cost variations by having time-of-use (TOU) energy retail prices—which may have a reduced demand related charge or it may be eliminated altogether (except for the network charge component where appropriate). This arrangement is only applicable where the underlying cost of energy supply can be ascertained with some degree of certainty for the TOU periods under consideration. With the de-regulated pool market, the underlying cost of energy to the Retailer—the pool price, is largely influenced by the supply bid of the marginal generator and the resulting price is very unpredictable.

An extension of the TOU energy prices is real-time pricing (RTP) and the PPT is one version of this. European Patent EP 0 999 418 A2 ‘Real-time pricing controller of an energy storage medium’ describes a method and apparatus for controlling an energy storage medium subject to RTP. RTP has two shortcomings; firstly, although it provides the opportunity to avoid high pool prices, it does not enable access to the high prices that occur in the pool. Secondly, it exposes the customer to the high prices in the pool whenever the customer is unable or unwilling to curtail energy consumption.

There is now renewed interest in Curtailment Pricing, where a customer with a standard contract for energy supply is offered a particular price for a particular period to reduce load by a given minimum quantity. The problem with this arrangement is the logistics of contacting the selected customers, making them the relevant price offers, and checking whether they have responded by reducing load at the appropriate time and by how much. The problem can cause grave difficulties when applied to a regime that determines pool price every half hour. The situation is further complicated by the difficulty in determining what is the appropriate offer price for curtailed load. Due to the logistical difficulties, curtailment offers are made only to large customers who generally place a higher value on a supply outage than smaller customers eg residential customers. They also involve substantial set-up costs and commitment payments that may not be recovered fully by the Retailer.

The present invention is an improvement on both the RTP and Curtailment pricing methodologies as it enables the end customer to make the choice of energy consumption/curtailment in real time based on access to the price difference between the prevailing pool price and the applicable contract price, and yet offers the fall-back protection of the contract price.

### SUMMARY OF THE INVENTION

In a first aspect, the invention provides a method of trading units of energy administered by a Merchant wherein the Merchant agrees with the customer a specified number of units to be supplied with a specified pricing schedule. The agreement further provides that as a result of actual energy drawn from the mains supply being different to the agreed number of units for that time interval, the end customer pays in addition to the contracted sum, the wholesale market pool price to the Merchant for any energy drawn from the mains supply in excess of the agreed number of units and receives from the Merchant an amount equivalent to the wholesale market pool price for any units of energy not drawn from the mains supply as per agreement, the agreement between the Merchant and end customer being in effect for a specified period of time, the method using a system operable to achieve a preferred trading outcome based upon factors including, the latest determination of the wholesale market pool price and it's future forecast, the energy draw from the mains supply for use at the premises, the characteristics of energy consuming devices installed at the premises, and criteria established by end customers reflecting their preferences.

In a preferred embodiment, the system operable to achieve a preferred trading outcome includes as a factor, the characteristics of energy substituting devices for the supply of energy from a source other than the mains supply.

The Merchant may have the option to add a price premium to the wholesale market pool price for any units of energy that are not drawn from the mains supply by the end customer as a result of the actual draw being less than the agreed number of units for that interval of time. Such a price premium may be applied as a result of any one or more of the following:

exposure to the market pool price on the part of the Merchant;

variation in the network congestion costs;

variation in the costs of ancillary services; or

variation in costs not previously considered when formulating the agreement between the Merchant and the end customer.

Where the customer has an alternate energy source and other arrangements so permit it, an embodiment of the invention would provide a per unit payment by the Merchant for any units of energy injected to the supply mains on similar terms to the payment for energy units not used out of the agreed quantity for that interval of time.

The end customer may monitor their energy traded with the Merchant and receive regular information regarding the wholesale market pool price and any Price Premium on offer, thereby enabling the end customer to determine the current Net Price Impact for that time interval according to the agreement with the Merchant.

The criteria reflecting end customer preferences may include assigning priorities to energy consuming devices and any substitute energy devices installed at the premises, defining for energy consuming devices the price levels at which the device should no longer consume energy traded with the Merchant, and defining, for substitute energy devices, the price difference between the substitute energy device marginal operating cost and the Net Price Impact, at which the substitute energy device should provide energy as an alternative to the energy purchased from the Merchant. It may also be that, the role of the Merchant is fulfilled by an intermediary supplier or assumed by the end customer.

In the instance that the premises is located in a geographic region where the pool price is determined at a time after consumption of the energy, the pool price is preferably set as zero, the net cost to the end customer thus becoming the price premium set by the Merchant, the contract then requiring the use of the price premium as the relevant settlement price for energy usage greater than or less than the agreed number of units, with the Merchant using its best estimate of the eventual pool price as the price premium, and the customer usage weighted average of the price premium not exceeding by a specified amount the customer usage weighted average pool price over the same period.

In the instance that the premises of an end customer is located in a geographic region where a net pool market operates, the pool price is preferably the price in the balancing market closest to real time.

In another aspect, the invention provides a system for monitoring and controlling the energy usage of an end customer wherein the end customer has agreed to purchase from a Merchant a specified number of units of energy according to a specified pricing schedule. The agreement further providing that as a result of energy drawn from the mains supply the end customer pays, in addition to the contracted sum, the wholesale market pool price to the Merchant for any energy draw from the mains supply in excess of the agreed number of units and receives from the Merchant an amount equivalent to the wholesale market pool price for any units of energy not drawn from the mains supply as per agreement for that particular interval of time, the agreement between the Merchant and end customer being in effect for a specified period of time, the system including:

a metering means operable to measure energy drawn from the mains supply for use at the premises of the end customer;

communication means operable to receive information relating to the wholesale market pool price for units of energy, said communication means operable to receive price information on a regular basis;

a computing means operable to accumulate information relating to traded energy consumption from the metering means and price information received by the communication means, said computing means being programmed to determine the price of units of energy as traded with the Merchant and operable to determine a preferred trading outcome based upon factors including the latest determination of the wholesale market pool price and it's future forecast, the energy consumption at the premises, the characteristics of energy consuming devices installed at the premises and criteria established by end customers reflecting their preferences; and

switching means operable to disconnect or reconnect the supply of energy to energy consuming devices, with the said switching means being activated to disconnect or reconnect energy supply when a set of criteria has occurred for those devices in an attempt to achieve the preferred trading outcome of the end customer.

In an embodiment of the invention, the computing means determines a preferred trading outcome by including a factor relating to the characteristics of energy substituting devices installed at the premises and the switching means is operable to connect an alternate energy supply from an energy substituting device to one or more of the energy consuming devices. Preferably, the computing means is operable to collect data regarding the criteria for the disconnection and connection of supply of energy to and from respective devices.

In another embodiment of the invention, the agreement between the end customer and the Merchant will extend the terms for the purchase by the Merchant of unused energy as per agreed schedule, to include also the purchase of any energy the customer injects into the supply mains (negative draw).

In a preferred embodiment, the criteria for each energy consuming device is able to be modified by the end customer, the criteria including any one or more of the following:

a price of units of energy above which a device is to be disconnected;

a price of units of energy below which a device is to be reconnected;

a priority level of a device as compared with other devices such that disconnection of devices from the energy supply occur in order of priority;

a period of time for which a response to a variation in price of units of energy is delayed in order to avoid rapid switching of a device;

a maximum period of time for which a device is to be disconnected from the energy supply; or

the minimum period of time the device is to be connected to the energy supply irrespective of the wholesale market pool price for units of energy.

Additionally, the end customer is able to set the criteria for each energy substituting device which may include any one or more of the following:

the relative price difference between the Net Price Impact and the marginal operating cost for the energy substituting device, above which an energy substitute device is to be connected;

the relative price difference between the Net Price Impact and the marginal operating cost for the energy substituting device, below which an energy substituting device is to be disconnected;

a priority level of a device as compared with other devices such that disconnection of a particular energy consuming device from the mains energy supply and the connection of the substituting energy device to that energy consuming device occurs in order of priority;

a period of time for which a response to a variation in price of units of energy is delayed in order to avoid rapid switching of a device;

where the energy consuming devise has energy storage properties, the current usage of storage capacity and it's maximum possible storage capacity.

Preferably, the switching means are in electrical communication with the computing means, the computing means thereby being operable to control the supply of energy to and from the devices. In a preferred embodiment, the switching means are able to be manually operated irrespective of the criteria established by end customers thereby enabling an end customer to over-ride the operation of the system in its attempt to achieve a preferred trading outcome. In a particularly preferred embodiment, the switching means provide a visual indication of their status and/or may have a timing element to reset the over-ride function after the lapse of a given time interval. It is preferable that the computing means be programmed to estimate the average price impact of using or not using units of energy for a period of time in the future so that the end customer may amend the criteria for each device. In a preferred embodiment, the entry of data forming the criteria for devices may be communicated to the computing means by way of the communication means thus enabling the end customer to establish or amend criteria locally from within the premises or remotely from outside the premises in which the devices operate.

In a preferred embodiment, a Display/Alert Unit (D/A unit) provides a visual display of the current and projected net cost of units of energy being traded by the end customer in accordance with the Merchant agreement as determined by the computing means, and the D/A unit providing an audible alarm when the net cost of trading is above a threshold set by the end customer. In a particularly preferred embodiment, a D/A unit provides a visual and audible alarm when the net cost of trading is above a threshold set by the end customer and the traded energy usage is greater than the units of energy specified for that time interval in the agreement with the Merchant. The D/A unit may use light emitting diodes to provide the visual display. Additionally, the D/A unit may use different colored light emitting diodes or different flashing frequencies to indicate ranges of the Net Price Impact of units of energy being drawn by the end customer and the ratio of the real-time consumption of units of energy as compared with the expected consumption level for that time interval according to the agreement with the Merchant.

For a D/A unit, light-emitting diodes may be used to signal to an end customer the forecast average pool price level or a forecast average Net Price Impact range over a defined period of time. The end customer may have a choice in selecting the audible output of the alarm unit contained within a D/A unit. In a particularly preferred embodiment, a suitably programmed computer remote from the premises or a suitably programmed mobile phone may perform the function of a D/A unit.

### BRIEF DESCRIPTION OF THE DRAWINGS

Features, objects and advantages of the present invention will be better appreciated by the detailed description and the embodiments illustrated in the attached drawings and tabulations.

FIG. 1 is a schematic overview of one embodiment of the invention in the context of an electricity supply situation, where the internal communications between the local computer and the main components being controlled is by means of RF transceivers. RF transceivers are usually covered by the HomeRF Shared Wireless Access Protocol (SWAP), which system is designed to carry both voice and data traffic and to interoperate with the Public Switched Telephone Network (PSTN) and the Internet.

Alternate methodologies are also applicable for the internal communication between the local computer and the components being accessed/controlled, eg an Ethernet network such as 10baseT supported by TCP/IP or by means of internal supply wiring at the premises using proprietary power line communication systems that are well accepted in the industry—such as the X10 protocol, now popular in the USA for home use

FIG. 2 is a block diagram giving a brief description of the functionality of the main application modules.

FIG. 3 is a flow diagram illustrating one embodiment of the control logic according to the invention as applied to the automatic switching (/turning “ON” or “OFF”) of electricity (gas) to designated loads and the connection of stand-by energy supply facilities.

FIG. 4 is a tabulation that illustrate the Impact of a High Price Spike under a Tariff regime, under a PPT pricing regime and according to the particular embodiment of the invention called the new Stapled Contract but with the control system de-activated.

FIG. 5 is an extension of the tabulation given in FIG. 4 where the working of the other parts of the invention results in a energy usage reduction according to set values of the pool price through a two step process.

FIG. 6 is a replication of FIG. 5 where the pool price spike that was previously shown to occur in the time interval ending at 16:30 hours is now shown as occurring in the time interval ending at 19:00 hours.

FIG. 7 is a replication of FIG. 6 but the level of the High Price Spike is now shown as equal to the pool price cap as applying in the NEM (500 c/kWh) and the energy use reduction program includes a third step—a usage reduction of 100% when pool price exceeds 400 c/kWh.

### DETAILED DESCRIPTION OF THE INVENTION

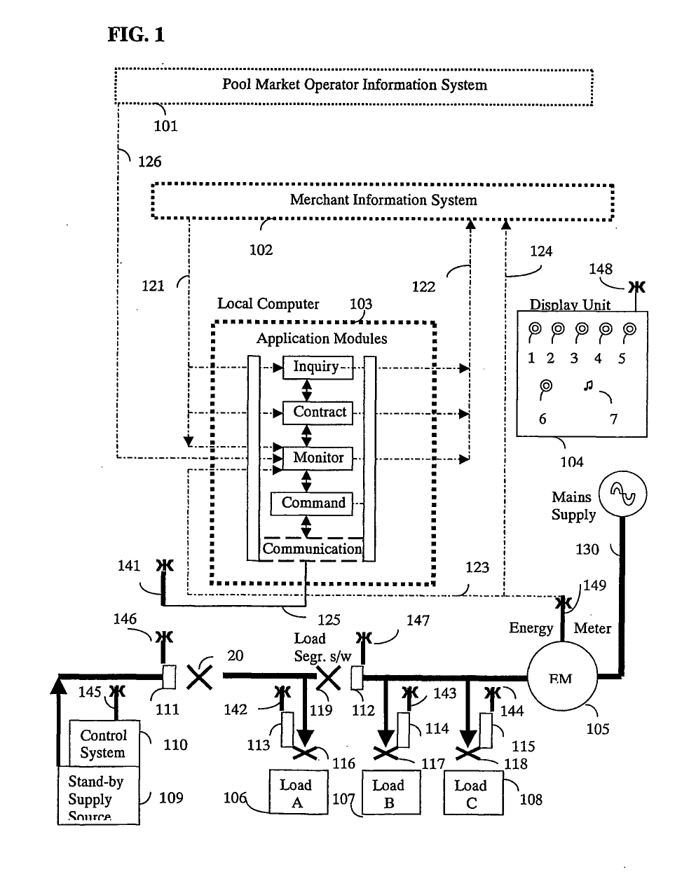

For clarity of description, the working of the invention is described in its application to one embodiment of the invention as depicted in FIG. 1 which is concerned with electricity supply and uses homeRF type of communication for systems control/data transfer requirements within the premises. The scope of the present invention allows for its application in the gas industry and for the use of other means of communication both internal to the premises and external to the premises.

Item 101 represents the Pool Market operator's computer information system.

Item 102 represents the Merchai?t's computer information system. With the current level of e-commerce functionality, the preferred embodiment for the communication links 121 and 122 are also via the world wide web (web), including wireless web. In this embodiment the Merchant makes available pool price and pool price forecast information via the web—the communication link 121, while there can be a back-up source of pool price information from the Pool Market Operators web site via communication link 126.

Item 105 is a meter capable of continuous measurement and has the capacity to store energy use readings (kilowatt hours) for periods representative of the pool price periods. Nowadays these meters are mostly electronic based with electronic registers to store the data or electro-mechanical meters supplemented with electronic registers and are also known as interval meters. These types of meters are widely deployed in many countries and are commercially available from a number of suppliers. These meters are usually linked to a communication device to enable remote reading at regular intervals as required by the pool market settlement system. The particular embodiment shown in FIG. 1 uses the RF transceiver (149) for communication purposes. It is also envisaged that there may be multiple communication paths (123, 124) from the one meter due to fact that the meter readings are required by number of other parties as well eg the Retailer and the network services provider.

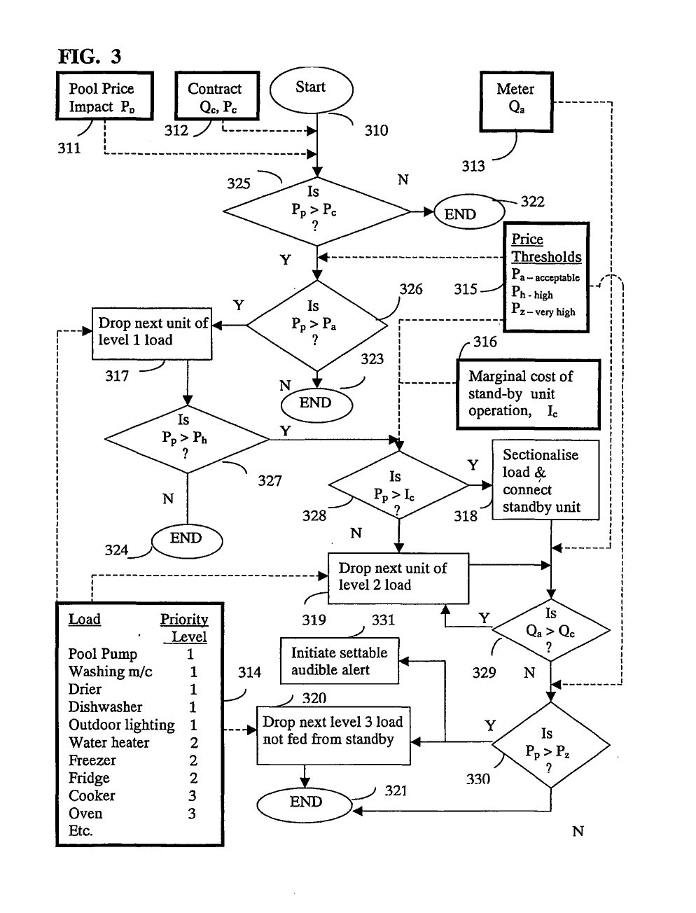

Mains supply (130) is shown as connected to three loads, load A (106), load B (107) and load C (108) passing through normally closed switches 116, 117 and 118. These switches are able to be opened and closed by the actuators 113, 114 and 115 respectively. It should be noted that these switches are in addition to the normal switches for manual use. The actuators get the control signal via RF transceivers 142, 143 and 144 respectively. In the case illustrated, load A is able to be isolated from the mains supply by the load segregation switch 119 and can be supplied via a stand-by power source 109— which could be a storage battery with an inverter system or a self start stand alone generator. The control for the stand-by unit is shown as 110 and has its own RF transceiver 145. The stand-by unit has its own isolating switch 120, actuator 111 and RF transceiver 146. The load segregation switch 119 also has its own actuator 112 and its RF transceiver 147. Only three loads have been included in the case illustrated in FIG. 1 to enhance clarity but in a typical household application there would be more appliances/loads—a typical listing being provided in data table 314 of FIG. 3. Table 314 also provides typical priority levels that can be set from within the Monitoring Module.

The D/A unit is shown as 104 and has it's own RF transceiver 148. This unit is depicted as having 5 light emitting diodes (LEDs) in the top row (1) to (5) with LED (6) in the bottom row together with a musical note (7) to denote an audible alarm capability which again can be set for two or more variations of output sound. This particular embodiment has this particular deployment of LEDs and audible alerts but other embodiments could have different deployments but following the same concepts. The working of the display LEDs and audible alert is further described under the Command Module heading. Where the occupants of the premises are away on a regular basis eg for work, it is possible to set-up the equivalent of the D/A unit functionality within a web client program running on a remote computer which is normally used by the occupant, or on a web enabled PDA usually carried by the occupier or by conveing relevant messages to a web-enabled mobile phone using the Wireless Application Protocol (WAP). For existing GSM phones, the signal could be encoded via a SMS text message facility accompanied by an alert beep.

Item 103 represents a local computer, local in that it is situated within the premises and a computer, in that it includes a processor and the required peripherals like power supply, operating system, memory, file storage, database, etc. As computer ownership is now widespread with almost all businesses having their own computer and in many countries more than half the households now have a home computer, the preferred embodiment is where the local computer is a Personal Computer (PC) capable of running software with web server functionality. It is not necessary to have a stand alone PC and it could well be a shared PC. Further the preferred embodiment is for the PC to be ‘ON’ the whole time and to have uninterrupted connection to the web preferably via a cable connection or an always ‘ON’ wireless arrangement. The local computer will act as the host computer running application server software enabling remote client access to monitor and change application settings in a secure manner. Remote access could be via the web and a remote computer, or a web enabled PDA, or web enabled mobile phone (WAP), or through a dial-up connection and voice recognition software with an appropriate interface facility at the local computer end.

Where the local computer is incorporated with the energy meter or with a home automation computer, the Application Modules according to the invention may reside in a separate application server on the home PC connected to the local computer by means of appropriate interface facilities. The home PC may also run as a web server forming the web link for communication with outside bodies.

Considering the functionality of current energy meters and the requirements for periodic downloading of interval usage data for pool settlement, there is merit in combining the local computer with the energy meter or at least housing it in the same box. Also considering the developments in wireless communication and the wireless web eg. WAP, High-Speed Circuit-Switched Data (HSCSD) and General Packet Radio Service (GPRS), there are advantages in combining the local computer with the cordless/mobile phone base unit or to have then housed side by side.

Having a local computer based control system overcomes a major stumbling block in current efforts to provide information to individual customers when and how much load to drop. By accessing the generally broadcast pool price information, the local computer can customize that general information to suit the specific circumstances of that customer by working out the Net Price Impact according to contained data on real-time energy use, the customer's relevant contract prices and quantities.

There are five application modules shown in FIG. 1, as it is convenient to deal with them as distinct blocks of activity. All internal and external communications are expected to flow through the communication module and the arrows depicting the communication links (121, 122, 123 and 126) are shown as terminating (via the communication module vertical extensions) in the respective application modules only for ease of comprehension. In reality, if a PC is being used and the web connections are in place, communication with say the Merchant via the web would appear seamless. For communication with the energy meter 105 and other items within the premises, there is a RF transceiver 141 connected via link 125.

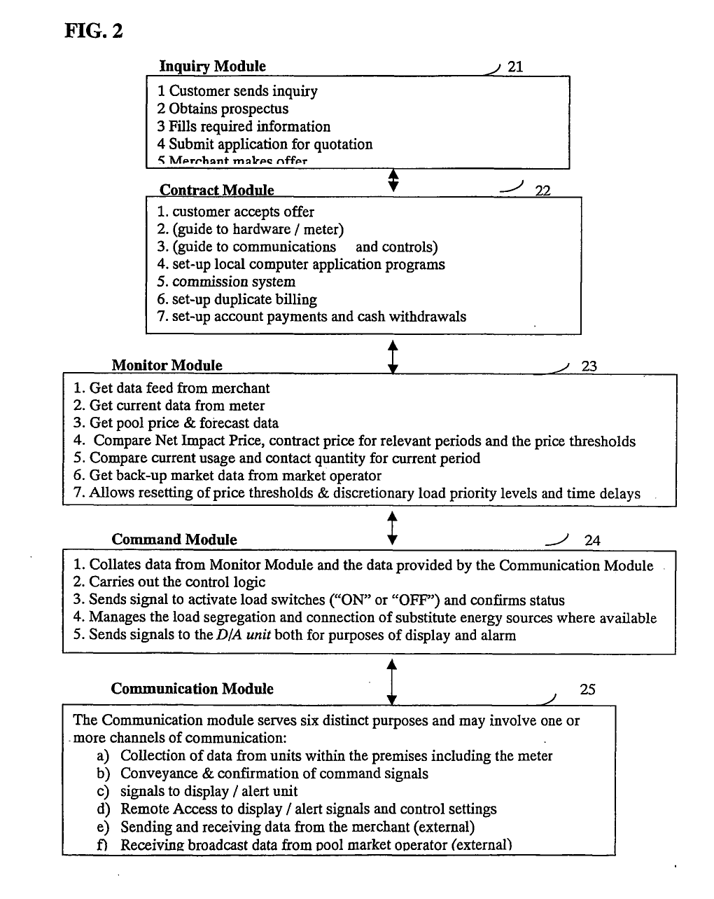

Key functionality of each application module is listed for easy reference in FIG. 2.

Inquiry Module

Considering that customers now can change supplier, the industry has to deal with ‘customer churn’, denoting frequent switching of suppliers. The inquiry module (21) allows the customer to capture the details of the inquiry, the data provided in the application and the offer, and facilitates future inquires. It also makes it easier for the Merchant to interact with the customer.

Contract Module

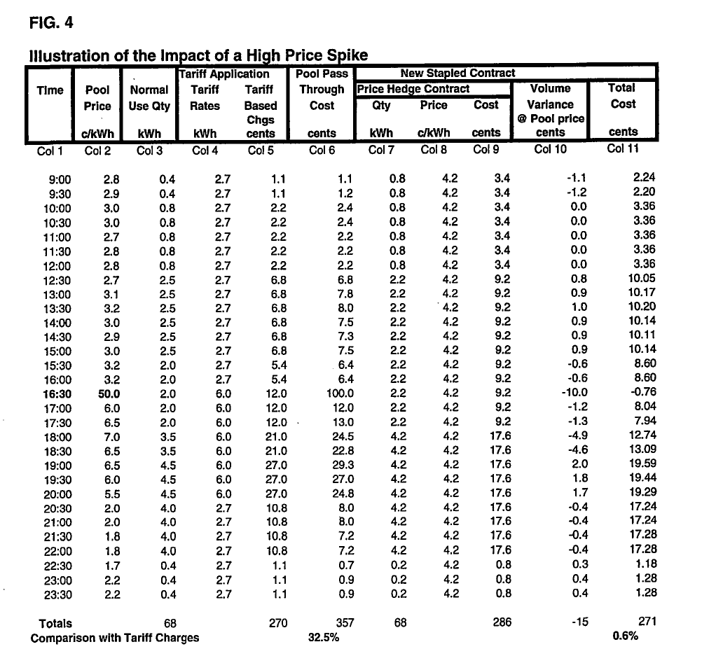

The Contract module (22) accesses data contained in the Inquiry Module and enables the customer to accept the offer made by the Merchant. As the pricing arrangements are a key part of the invention, they are covered below under the heading Pricing Arrangements. Representative values for standard tariffs, PPT price offers and a typical price offer according to the invention are shown in FIG. 4.

The Contract Module also contains the Customer Instructions/User Guide to the hardware, meter and communications aspects and on request, the Merchant will normally arrange their installation and commissioning.

The Contract Module will also have the capability to duplicate the billing process, ie to calculate the payments that accrue according to the contact terms using the energy consumption data available in the Monitor Module. The advent of net banking makes it easy to set-up facilities to pay bills via the internet or to request the Merchant to release part or whole of the credit balance available to the customer as the case may be. The Merchant will have its own bifing system, which will do its own calculations and verify the balance before arranging any payments. By running a duplicate bill calculation routine in the local computer, the customer gets immediate feedback on the impact of efforts to respond to pool price excursions.

Monitor Module

The Monitor Module (23) initiates data acquisition from the pool market operator and the Merchant, which in this embodiment of the invention is via their web sites. In other embodiments this data access would be through a means such as a direct connection via dial-in, through wireless communication eg Tele-text or through power-line carrier. The information from the market operator may include pool prices, pool price forecasts and market notices. The information sent by the Merchant may include a relay of the market operator's data plus special price premiums the Merchant is prepared to offer if the situation so warrants it. The Monitor Module also monitors the status of all active components like the meter, switches and the D/A unit, and regularly downloads interval consumption data contained in the meter registers.

The Monitor Module also compares energy consumption quantities with contacted quantities for the relevant period as well as the pool price and it forecast against the relevant contract prices, which information it passes on to the Command Module and the D/A unit. To enable the control logic to take account of the price premium that may be offered by the Merchant, the control system uses the Net Impact Price. Where the communication and server facilities so permit, the Monitor Module will be able to replicate the signal sent to the D/A unit also to a remote computer, and or a PDA or a mobile phone. All control parameters like price thresholds, load priority levels, time delays, etc are contained in tables within this module and are accessible/modifiable by the customer with appropriate security safeguards. Where the local computer has remote access facilities as described above, the settings can also be controlled remotely. The monitor Module also carries out data and system back-up as programmed. As part of the back-up process it is able to confirm the data integrity by comparing check totals with the appropriate data from the Merchant's computer system.

The pool price forecast information generally provided by the pool market operator and/or the Merchant is regularly updated and when transmitted by the Monitor Module to the D/A unit, enables the premises occupier to plan the regular use of energy devices in a manner similar to the housewife looking out of the window to decide whether to do some washing which can then be put on the outdoor clothesline to dry.

Command Module

It is convenient to consider all ‘command’ type activity as being included in the Command Module (24). FIG. 3 provides a simplified flow chart of the key control cycle performed by the Command Module confined to the control of switches in the system and the initiation of the audible alert. Internal loops, time delays, etc have been omitted for clarity. The illustration cover three Price Threshold levels (table 315) and three Priority Levels (table 314) for the different load units, but in practice it is possible to have more or less Priority Levels as desired. Contract quantity and price (Q_{c}, P_{c}) applicable to a given time interval are indicated in 312, while the relevant meter data (Qₐ) and Pool Price Impact data (Pₚ) are indicated in 313 and 311 respectively. Marginal cost of operation of the stand-by supply unit (I_{c}) for that time interval is given in 316.

Control cycle is initiated from Start (310) and terminates at the End (321, 322, 323, and 324). The cycle repeats after a set time delay or if there is a change in Pool Price Pₚ or Contract terms Q_{c}, P_{c} or the Metered quantity Qₐ (as applied to that time interval). The Logic Steps involved are given in decision boxes 325, 326, 327, 328, 329 and 330. Data inputs from the darkened data boxes 210, 211, 212, 213, 214, 215 and 216 are indicated with broken lines.

Activities 317, 319 and 320 send the signal to shed load units according to priority levels 1, 2 and 3 respectively. The corresponding control components for re-connecting these loads are not shown so as not to complicate the flow chart. Activity 318 will send the signal to open the load segregating switch eg 119 in FIG. 1 and connect the stand-by supply source eg 109 in FIG. 1 to the relevant load unit eg Load A (106). Activity 331 initiates the settable audible alert contained in the D/A unit.

The Command Module also initiates the signals to be sent to the D/A unit. Typical logic steps driving this activity is illustrated below and is in reference to a D/A unit such as item 104 in FIG. 1 containing six Light Emitting Diodes (LEDs) 1 to 6 and an audible alarm 7 (all of which are contained within 104):

If current time (t) pool price (Pₚ, t)<contract price (P_{c}, t), set indicator LED 1 to flash green

If forecast pool price for the hour t+1 (Pₚ, t+1) is <(P_{c}, t+1), set LED 2 to flash green

If forecast pool price (Pₚ, t+2) is <(P_{c}, t+2), set LED 3 to flash green

If forecast pool price (Pₚ, t+3) is <(P_{c}, t+3), set LED 4 to flash green

If avg. forecast Net Impact Price (Pₚ, t+4 to t+7) is <avg. P_{c} for that period, set LED 5 to flash green

If (Pₚ, t)=(P_{c}, t) but <first price threshold (Pₐ), set LED 1 to green

If forecast pool price (Pₚ, t+1) is =(P_{c}, t+1) but <Pₐ, set LED 2 to green

If forecast pool price (Pₚ, t+2) is =(P_{c}, t+2) but <Pₐ, set LED 3 to green

If forecast pool price (Pₚ, t+3) is =(P_{c}, t+3) but <Pₐ, set LED 4 to green==

If avg. forecast pool price (Pₚ, t+4 to t+7) is =avg. P_{c} for that period, but <Pₐ, set LED 5 to green

If (Pₚ, t)>(P_{c}, t) and =Pₐ but <Pₕ, set LED 1 to yellow & do step (A)

If forecast pool price (Pₚ, t+1) is >(P_{c}, t+1) and =Pₐ but <Pₕ, set LED 2 to yellow

If forecast pool price (Pₚ, t+2) is >(P_{c}, t+2) and =Pₐ but <Pₕ, set LED 3 to yellow

If forecast pool price (Pₚ, t+3) is >(P_{c}, t+3) and =Pₐ but <Pₕ, set LED 4 to yellow

If avg. forecast pool price (Pₚ, t+4 to t+7) is >avg. P_{c} for that period and =Pₐ but <Pₕ, set LED 5 to yellow

If (Pₚ, t)=Pₕ but <P_{z}, set LED 1 to red & do step (13)

If forecast pool price (Pₚ, t+1) is =Pₕ but <P_{z}, set LED 2 to red

If forecast pool price (Pₚ, t+2) is =Pₕ but <P_{z}, set LED 3 to red

If forecast pool price (Pₚ, t+3) is =Pₕ but <P_{z}, set LED 4 to red

If avg. forecast pool price (Pₚ, t+4 to t+7) is =Pₕ but <P_{z}, set LED 5 to red

If (Pₚ, t)=P_{z}, set LED 1 to flash red, activate audio alert (7) at ‘low’ & do step (C)

If forecast pool price (Pₚ, t+1) is =P_{z}, set LED 2 to flash red & activate audio alert (7) at ‘low’

If forecast pool price (Pₚ, t+2) is =P_{z}, set LED 3 to flash red & activate audio alert (7) at ‘low’

If forecast pool price (Pₚ, t+3) is =P_{z}, set LED 4 to flash red & activate audio alert (7) at ‘low’

If avg. forecast pool price (Pₚ, t+4 to t+7) is =P_{z}, set LED 5 to flash red & activate audio alert (7) at ‘low’

If current consumption Qₐ>contract quantity Qc then set LED 6 to red else set to green

If Qₐ>Q_{c} and (Pₚ, t)>Pₕ but <P_{z}, then set LED 6 to flash red and activate audio alert (7) at ‘low’

If Qₐ>Q_{c} and (Pₚ, t)=P_{z}, then set LED 6 to flash red and activate audio alert (7) at ‘high’.

Step A

Send signal to shed next Priority Level 1 load as per load priority table (314). A time delay (say two cycles) as set by the end customer will apply, so that the load that is shed gets automatically re-connected on the second consecutive cycle without a repeat signal.

Step B

If (Pₚ, t)>I_{c}(the marginal cost of operating stand-by facilities), send signal to open load segregation switch and start/connect stand-by facilities to segregated load.

If (Pₚ, t)<I_{c} and the stand-by facilities are connected, a time delay (say 15 minutes) will apply before sending signal to shut-down stand-by facilities and reconnect sectionalized load. A converse signal will abort the activity that was delayed.

If Qₐ>Q_{c} send signal to shed also Priority Level 2 load as per priority table (314). A time delay (say two cycles) will apply, so that the load that is shed gets automatically re-connected on the second consecutive cycle without a repeat signal.

Step C

Send signal to shed also Priority Level 3 load as per load priority table (314). A time delay (say two cycles) will apply, so that the load that is shed gets automatically connected back on the second consecutive cycle without a repeat signal.

Note: Time delays mentioned can be set by the end customer from within the Monitor Module.

Communications Module

The main entities linked via the Communications Module are listed in 25 of FIG. 2.

Communication with parties external of the premises is preferably via the internet, through a permanent connection. RF communication and the wireless web would also be suitable candidates.

As described above, various communication means enable the local computer to access pool price information in near real time as well as pool price forecasts usually from 6 to 12 hours in advance.

The applications programs, the disposition of the load shedding and stand-by facilities in conjunction with the control system enables the customer to respond automatically in real time according to preset parameters. The important thing is that all the settings are under the control of the customer, which control can now be exercised even when the customer is on the ‘move’ away from the premises, by use of a mobile phone and voice recognition software or through the wireless internet.

The Communications Module would also have the functionality (eg internet server software) to access the PC for remote monitoring from another location either through another PC or a web-enabled cellular phone or web enabled personal digital assistant (PDA). It would also be possible to install voice recognition software which will enable the PC to be interrogated/instructed via a mobile phone.

Depending on the customer's particular circumstances the choice of the communication channel would be different and the state of the art is such that a ‘mix and match’ of communication modes appropriate to specific parts of the system is also possible.

Pricing Arrangements

Pricing arrangements are a key part of the invention and play a major role in the distribution of the economic benefits from the invention A preferred embodiment of the invention would have two components in the pricing package, one component that provides protection from high prices that occasionally occur in the pool and the other component to give a substantial incentive to the customer to reduce energy usage when pool prices are high. Typical TOU tariff rates are shown in Column 4 of FIG. 4-Illustration of the Impact of a High Price Spike. Column 1 is a time stamp of the end of the time interval, while Column 2 indicates the pool price for that time interval. Time intervals are 30 minutes, similar to the time intervals used for market settlement in the NEM. Typical pool prices are shown in Column 2. A typical small customer's electricity usage is shown in Column 3 and based on these the resulting tariff charges are given in Column 5, while Column 6 gives the cost if the customer was to be charged according to the prevailing pool price—PPT pricing.

In the embodiment of the invention illustrated in FIG. 4, one component of the price package is a Price hedge contract—which guarantees a fixed price for a specified quantity of energy for every half hour, typical values being shown in Columns 8 and 7 respectively. Column 9 shows the costing for this component of the price package. The other component of the price package is an arrangement where the variance in customer's actual usage compared to the specified quantity is settled between the two parties at the prevailing pool price. This computation is shown in Column 10, being a negative amount when the actual usage is less than the specified amount of energy and vise versa. The total cost to the customer is then the sum of these two components and is shown in Column 11. For easy reference this price package will be called the New Stapled Contract.

FIG. 4 shows that a significant Price Spike (50 c/kWh) has occurred during the price period ending at 16:30 because of which the PPT cost is substantially higher (+32.5%) while the cost under the New Stapled Contract is only marginally different (+0.6%) when compared to the cost under the Tariff regime.

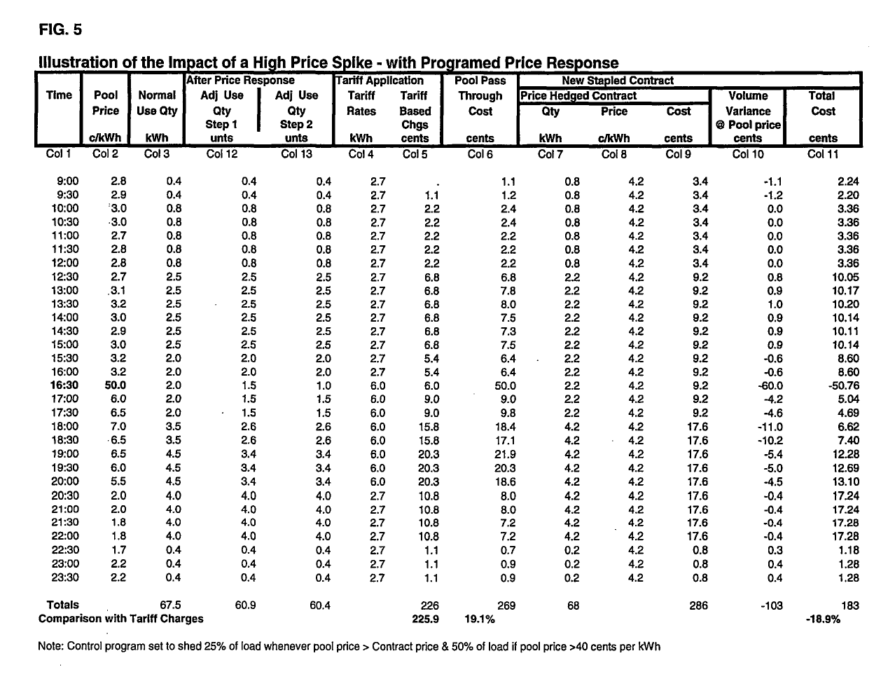

FIG. 5 shows the variation in energy usage due to the action of the other parts of the invention.

The case illustrated has been simplified for easy comprehension and is shown as involving a two step usage reduction regime, step 1—which will shed 25% of the connected load when the pool price (equal to Net Impact Price as there is no Price Premium) is greater than the Price Threshold (Pₐ) in Table 315 which is set equal to the contracted price. Step 2 will shed 50% of the normal connected load when the pool price is greater than the Price Threshold (Pₕ) which is set equal to 40 c/kWh. Steps 1 and 2 would correspond to the priority levels for loads described in the context of Table 314 and the resulting adjusted energy use is shown in Columns 12 and 13 respectively. The Tariff calculation (Column 5), the PPT calculation (Column 6) and the New Stapled Contract Volume Variance calculation will now be based on the reduced energy usage given in Column 13.

It is worth noting that the energy usage reduction in Step 1 is 7.1 kWh (now 60.4 kWh compared to original usage of 67.5 kWh), while the reduction from Step 2 is only 0.5 kWh. Due to the reduced energy usage, the charges under the Tariff has now come down to 227 cents (previously 270 cents), the PPT Cost is now only 18% higher than the new Tariff cost and the New Stapled Contract has achieved a saving of 19.3% compared to the new charges under the Tariff.

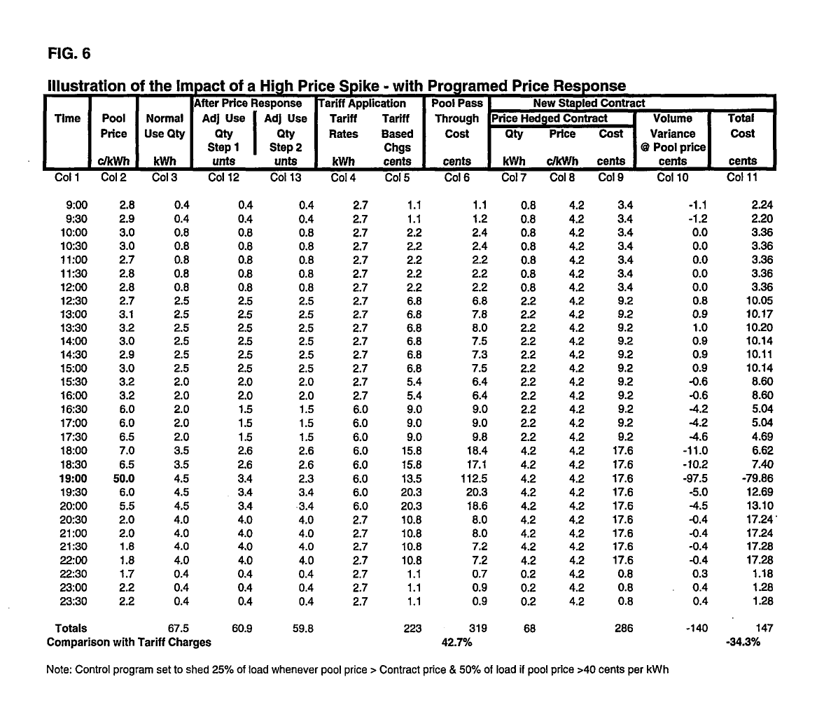

FIG. 6 shows the same set of calculations but this time the pool price spike occurs in the time interval ending at 19:00 hours (with normal usage 4.5 kWh) instead of at the time interval ending at 16:30 hours (with normal usage 2.0 kWh). It is worth noting that the energy usage reduction from Step 1 now becomes 6.6 kWh (60.9 kWh compared to original usage of 67.5 kWh), while the reduction from Step 2 has widened to 1.1 kWh. Due to the altered reduced energy usage pattern, the charges under the Tariff has now come down further to 223 cents (previously 226 cents), the PPT Cost has now gone up to being 42.7% higher than the new Tariff cost and the New Stapled Contract has achieved a significantly greater saving of 34.3% (previously 19.3%) compared to the new charges under the Tariff.

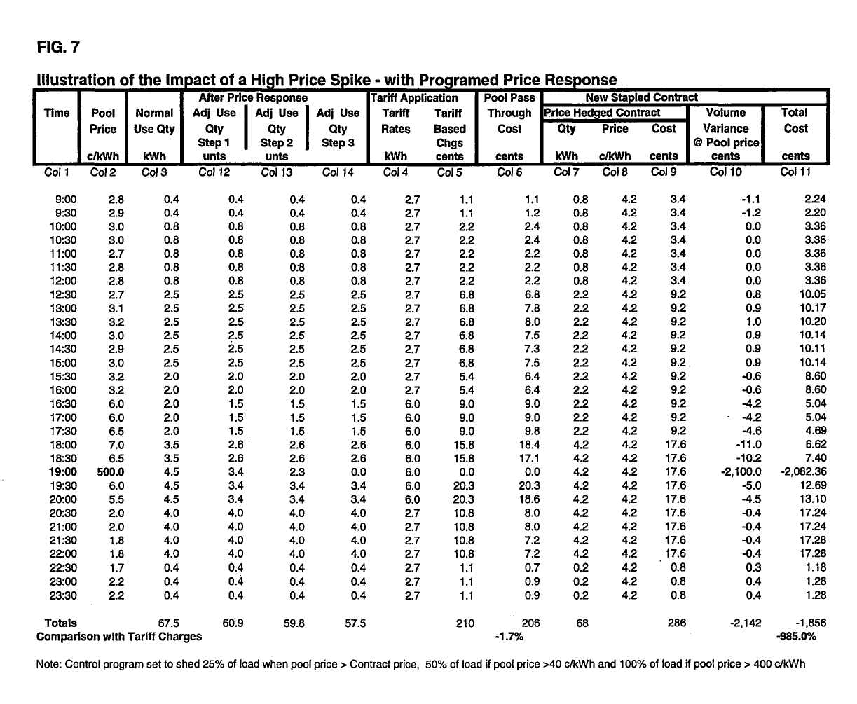

As the pool price cap can be significantly higher than 50 c/kWh, the benefits to the customer will increase as the price spike gets closer to the pool price cap. FIG. 10 illustrates the situation when the price spike reaches 500 c/kWh, which is the existing price cap in the NEM (or $5,000/MWh). There is little doubt value conscious customers would prefer to trade their full entitlement of energy use at such high prices. FIG. 7 introduces Step 3 in the price response program corresponding to priority level 3 described in the context of Table 314. Step 3 illustrated for this embodiment of the invention shows a 100% energy use reduction when pool price exceed Price Threshold (P_{z}) which is set at 400 c/kWh. The new energy use as a result of step 3 is shown in Column 14 of FIG. 7. The aggregate energy use changes to 57.5 kWhs with corresponding reduction in Tariff charges to 210 cents. The PPT cost is now less than the Tariff charge by 1.7%, while the charge under the New Stapled Contract becomes negative (ie customer gets money back) and is equivalent to a huge reduction of 985% compared to the Tariff charge for the altered usage. It is worth noting that the pool price cap in the Australian electricity pool market will rise to 1,000 c/kWh ($10,000/MWh) in April 2002. When that happens, the price reduction under the New Stapled contract becomes still greater—a whopping reduction of 1872%, with no change to the charges under the Tariff or in the PPT cost.

Other Embodiments of the Invention

a) Embodiment of the invention in the Victorian Gas Market context needs to recognize the special characteristics of the market. The Victorian Gas Market is a net pool market settling only the ‘overs’ and ‘unders’ from firm bilateral contracts. The bids into the pool are in the form of increments ‘Inc’ or decrement ‘Dec’ for both injecting into and withdrawing from the transmission system. There is a single daily market price determined at the end of each gas day, based on the bid stack and the actual gas demand for the day. One embodiment of the invention for a Victorian gas customer will use the ‘best estimate’ price provided that day morning by the Merchant in place of the usual Pool Price and the Net Impact Price will in addition incorporate any price premium the Merchant may wish to include. Because the morning forecast price may be different from the actual pool price, the reference to pool price in eg. the New Stapled Contract, will be taken as reference to the ‘best estimate’ price and not the actual pool price. If the Merchant is different from the Retailer, the customer will settle with the Merchant in the manner described above but the Merchant has to settle with the Retailer at the relevant pool price. Unlike in the case of the NEM the Victorian Gas Market Operator does not provide a medium term forward forecast of gas pool prices, only providing a forecast of forward demand. Therefore the embodiment of the invention for Victorian gas customers will instead use a forward pool price forecast provided by the Merchant.

b) In other net pool markets that balance supply and demand forecast in two or more steps eg day ahead and the day of, one embodiment of the invention would use the pool price determined closest to the moment of use as the applicable pool price. Near real-time response by end use customers according to the invention will then impact on the final imbalance and so the applicable price is the latest price set for that time interval.

c) In yet other pool markets there are supplementary pool markets for some of the components normally incorporated in an all-inclusive energy pool price. Some of these component markets include items such as Ancillary Services and Network Congestion Management Options. Depending on the location of the customer and the nature of the individual market mechanisms, price impact to the customer can be complicated. In some markets these components can be very significant and needs to be considered. The complexity involved is well within the capability of the Merchant and it would be sufficient for the customers' purposes for this component to be included in the Net Impact Price as an additional premium to be determined by the Merchant.

d) A customer, whose circumstances require a stand-by power unit, eg airport or high rise building or computer center with a Un-interrupted Power Supply (UPS) system, etc, would find the use of the invention very profitable. One embodiment of the invention for such a customer would not require actual load shedding, but the load on the mains system is reduced when the control system actuates the stand-by power unit. According to the invention, following the assessment by the control unit of a high Net Impact Price signal, the load segregation switches will open and the normally open isolator to the stand-by source will close, maintaining supply to the load so segregated. Because the financial impact of pricing arrangements such as the New Stapled Contract depends on the energy draw from the mains supply, the customer will benefit according to the capacity of the stand-by unit and the size of the segregated load. If for example, the stand-by unit has a rating of 550 kW and the segregated load is 500 kW, for a three hour price spike equal to the price cap of $5,000/MWh, the customer's financial benefit will be close to $7,000. Because the system is automated, the cutting in and cutting out—would be seamless if it involves a proper UPS system. For non-UPS applications involving items like lifts, lighting, HVAC, refrigeration, etc, the stand-by generating unit cutting-in would be barely felt.

Such an embodiment of the invention would enable customers who have stand-by generation facilities to set the control parameters in such a manner that their stand-by plant automatically runs much like a ‘peaking market generator’ with access to almost the full extent of the high pool prices or even a still higher price if the Merchant decides to add a price premium.

The particular embodiment is equally applicable to small customers having an alternate energy resource such as solar panels or fuel cells. Instead of having an arrangement that uses the power from such alternate source to reduce the overall billed consumption, trading the energy so generated according to the invention will provide far greater benefits, especially if the alternate energy is generated during the peak period when pool prices are generally higher. The benefits are still more if buffering is possible by the use of rechargeable batteries or other energy storage devices. Where the generation facility is small and supply frequency matching is not a problem, it may be possible to do without load segregation.

e) In another embodiment of the invention when applied to a gas supply, the local computer will be equipped with facilities to send a signal to turn ‘OFF’ normally ‘ON’ control switches fitted to designated loads eg in the home the type of appliances envisaged are: space heating units, water heaters, pool water heaters; these switches may have manual override so that the customer can operate them if so desired but it would be a conscious decision. In an industrial or commercial setting this may include switches on water heaters, specified air conditioning loads, ovens, process pre-heaters, etc which are in a designated scheme that allow reducing output from ‘normal’ to a ‘minimum required’ level of output.

f) In another embodiment of the invention where the local computer at the customer premises is able to calculate the customer's bill, the local computer will maintain:

an account balance showing the consumption since the last issued bill,

an account balance showing the charge for that amount of consumption and the credit earned in that period whenever consumption was less than the contract amount at a time when the pool price was above the contract price,

payment and arrears details as regularly updated by the Merchant's system computer and

a withdrawable component balance according to arrangements with the Merchant.

g) In another embodiment of the invention where the local computer at the customer premises maintains a withdrawable component balance as described above, the local computer will have the capabilty to convey the customer instructions to the Merchant—to transfer to customer designated bank or other similar account, the whole or part of the monies shown as the withdrawable balance. If such a transfer is affected the withdrawable balance will be reduced by the amount of the withdrawal and an advice will be sent to the customer by electronic means confirming the transfer.

h) In another embodiment of the invention, an already installed or intended premises automation system or a premises security system or a premises lighting &/or HVAC system, will incorporate the key features of the invention so as to enable the occupiers of the premises to benefit from high pool prices as described above. In some environments eg for LonWorks ™ by Echelon Corporation, the Application Modules according to the invention, may reside in the host computer running the Network Services Server software or may reside in a separate application server (remote host) connected to the Network Services Server by means of appropriate interface units.

i) In another embodiment of the invention, the contract module will have the functionality required to facilitate retail customer transfers as per guidelines by relevant authorities.

Although the present invention has been described with reference to preferred and other embodiments, numerous other arrangements may be devised by one skilled in the art, without departing from the spirit or scope of the invention. Modifications and substitutions to the present invention made in view of these teachings is considered to be within the scope of the present invention, which is not to be limited except by the claims which follow.

1. A method of trading units of energy administered by a merchant wherein the merchant agrees with the end customer a specified number of units to be supplied with a specified pricing schedule such that as a result of energy drawn from the mains supply during a particular interval of time, the end customer pays in addition to the contracted sum, the applicable wholesale market pool price to the merchant for any energy drawn from the mains supply in excess of the agreed number of units and receives from the merchant an amount equivalent to the applicable wholesale market pool price for any units of energy not drawn from the mains supply out of the number of units agreed for that time interval, the agreement between the merchant and end customer being in effect for a specified period of time, the method using a system operable to achieve a preferred trading outcome based upon factors including, the terms of the agreement with the merchant, the current rate of energy draw from the mains supply for use at the premises, the characteristics of energy consuming devices installed at the premises, and criteria established by end customers reflecting their preferences.

2. A method according to claim 1 wherein the system operable to achieve a preferred trading outcome includes as relevant factors, the characteristics of energy substituting devices for the supply of energy from a source other than the mains supply.

3. A method according to claim 1 wherein the Merchant has the option to add a price premium to the wholesale market pool price for any units of energy that are not drawn from the mains supply by the end customer as a result of the actual draw being less than the agreed number of units for that interval of time.

4. A method according to claim 1 wherein the added price premium may be applied as a result of any one or more of the following:
exposure to the market pool price on the part of the Merchant;
variation in the network congestion costs;
variation in the costs of ancillary services;
variations in cost not previously considered when forming the original agreement between the Merchant and the end customer.

5. A method according to claim 1 wherein the payment by the Merchant for a shortfall in the energy drawn from the mains out of the specified number of energy units in a particular interval of time, is extended to also provide similar terms of payment for any energy injected to the supply mains during that interval of time from an energy source situated within the customer's premises.

6. A method according to claim 1 any one of the preceding claims wherein the end customer monitors the energy traded with the Merchant and receives regular information regarding the wholesale market pool prices thus enabling the end customer to determine the current price of units of energy and their Net Price Impact according to the agreement with the Merchant.

7. A method according to claim 6 wherein the criteria reflecting end customer preferences include: assigning priorities to energy consuming devices and any substitute energy devices installed at the premises; defining for those energy consuming devices—the price levels at which the device should no longer consume energy traded with the Merchant, and defining, for substitute energy devices, the price difference between the substitute energy device marginal operating cost and the Net Price Impact according to the agreement, at which the substitute energy device should provide energy from an alternative source in place of the energy traded with the Merchant or provide energy to be injected into the supply mains.

8. A method according to claim 1 wherein the role of the Merchant is fulfilled by a supplier or the end customer.

9. A system for monitoring and controlling the energy usage of an end customer situated within the boundaries covered by a pool type wholesale energy market where the end customer has agreed to purchase from a Merchant a specified number of units of energy according to a specified pricing schedule, according to which agreement the end customer pays in addition to the contracted sum, the wholesale market pool price to the Merchant for any energy drawn from the mains supply in excess of the agreed number of units and receives from the Merchant an amount equivalent to the wholesale market pool price for any units of energy not drawn from the mains supply as agreed for that interval of time, the agreement between the Merchant and end customer being in effect for a specified period of time, the system including:
a metering means operable to measure energy drawn from the mains supply for use at the premises of the end customer;
communication means operable to receive information relating to the wholesale market pool price for units of energy, said communication means operable to receive pricing information on a regular basis;
a computing means operable to accumulate information relating to traded energy consumption from the metering means and price information received by the communication means, said computing means being programmed. to determine the price of units of energy as traded with the Merchant and operable to determine a preferred trading outcome based upon factors including the terms of the agreement with the Merchant, the energy consumption at the premises, the characteristics of energy consuming devices installed at the premises and criteria established by end customers reflecting their preferences; and
switching means operable to disconnect or reconnect the supply of energy to energy consuming devices with the said switching means being activated to disconnect or reconnect energy supply when a set of criteria has occurred for those devices in an attempt to achieve the preferred trading outcome of the end customer.

10. A system according to claim 9 whereby the computing means determines a preferred trading outcome by including factors relating to the characteristics of energy substituting devices installed at the premises and the characteristics of the energy consuming devises that can be supplied energy by the energy substituting devices, and the switching means is operable to connect an alternate energy supply from an energy substituting device to the relevant energy consuming devices, including where necessary the segregation of that device from the mains supply.

11. A system according to either claim 9 wherein the computing means is operable to collect data regarding the criteria for the disconnection and reconnection of supply of energy to and from respective devices.

12. A system according to claim 11 wherein the criteria for each energy consuming device is able to be modified, the criteria including any one or more of the following:
a price of units of energy above which a device is to be disconnected;
a price of units of energy below which a device is to be reconnected;
a priority level of a device as compared with other devices such that disconnection of devices from the energy supply occur in order of priority;
a period of time for which a response to a variation in price of units of energy is delayed in order to avoid rapid switching of a device;
a maximum period of time for which a device is to be disconnected from the energy supply; or
the minimum period of time the device is to be connected to the energy supply irrespective of the wholesale market pool price for units of energy;
the real-time energy storage capacity levels and the respective maximum possible energy storage capacities of energy consuming devices that have energy storage capabilities.

13. A system according to claim 11 wherein the criteria for each energy substituting device is able to be modified, the criteria including any one or more of the following:
the relative price difference between the net trading price impact and the operating cost of the energy substituting device, above which an energy substitute device is to be connected;
the relative price difference between the net trading price impact and the operating cost of the energy substituting device, below which the energy substituting device is to be disconnected;
a priority level of a device as compared with other devices such that disconnection of a particular energy consuming device from the mains energy supply and the connection of the substituting energy device to that energy consuming device occurs in order of priority;
a period of time for which a response to a variation in price of units of energy is delayed in order to avoid rapid switching of a device;
the real-time energy storage capacity levels and the respective maximum possible energy storage capacities of energy consuming devices that have energy storage capabilities and are able to be supplied energy by the energy substituting devices.

14. A system according to claim 9 wherein the switching means are in communication with the computing means so that the computing means is thereby operable to control the supply of energy to and from said devices.

15. A system according to claim 9 wherein at least one of the switching means are able to be manually operated irrespective of the criteria established by the end customer, thereby enabling the end customer to over-ride the operation of the system in its attempt to achieve a preferred trading outcome with respect to devices connected to that switching means.

16. A system according to claim 9 wherein at least one of the switching means provides a visual indication of its status and/or may have a timing device to reset the manual over-ride function after a lapse of a time period as set by the end customer.

17. A system according to claim 9 wherein the computing means is programmed to estimate the average Net Price Impact of using or not using units of energy for a period of time in the future—thereby providing relevant information to the end customer to enable amendment of the criteria for each device and/or alter the manual usage pattern of load devices based on that information.

18. A system according to claim 9 wherein the entry of data forming the criteria for devices is communicated to the computing means by way of the communication means thus enabling the end customer to establish or amend criteria locally from within the premises or remotely from outside the premises in which the devices operate.

19. A method according to claim 1 for premises located in a geographic region where the wholesale pool price is determined at a time after consumption of the energy wherein the pool price is set as zero and the net cost to the end customer is the price premium set by the Merchant, the agreement in such a case requiring the use of the price premium as the relevant settlement price, for any units of energy drawn which are greater than or lesser than the agreed amount, the Merchant required to use its best estimate of the eventual pool price as the price premium, preferably in accordance with an agreed methodology to ensure an equitable outcome.

20. A method according to claim 1 for premises located in a geographic region where a net pool wholesale market operates wherein the pool price to be used is the price in the balancing market closest to real time.

21. A system according to claim 9 including at least one D/A unit which provides a visual display of the current and projected Net Price Impact as determined by the computing mans, of energy being traded with the end customer as per agreement with the Merchant, and at least one D/A unit provides an audible alarm when the Net Price Impact is above a threshold set by the end customer.

22. A system according to claim 21 wherein at least one D/A unit provides a visual and audible alum when the Net Price Impact is above a threshold set by the end customer and the traded energy usage is greater than the units of energy specified in the agreement with the Merchant for that time interval.

23. A system according to either claim 21 wherein the at least one D/A unit uses a selection of light emitting diodes to provide a visual display of some of the key parameters having an influence or likely to have an influence on the energy trading outcome.

24. A system according to claim 21 wherein the at least one D/A unit uses different colored light emitting diodes or different flashing frequencies to indicate different value ranges for the Net Price Impact of the energy being supplied to the end customer and for the ratio of current consumption of energy as compared to the expected consumption level for the same time interval according to the agreement with the Merchant.

25. A system according to claim 21 wherein the at least one D/A unit uses light emitting diodes to represent a forecast average pool price or a forecast average Met Price Impact over a defined period of time.

26. A system according to claim 21 wherein the end customer can select from a range of formats for the audible alarm contained in the D/A unit.

27. A system according to claim 21 wherein the functionality of a D/A unit is able to be provided by a suitably programmed remote computer and/or a suitably programmed mobile phone.
